(19) United States
(12) Patent Application Publication
(10) Pub. No.: US 2015/0288578 A1
(43) Pub. Date: Oct. 8, 2015

(54) InstaLink: Instant Provisioning of Network Services

(71) Applicant: CenturyLink Intellectual Property LLC, Denver, CO (US)

(72) Inventors: Thomas Schwengler, Lakewood, CO (US); Michael L. Elford, Calhoun, LA (US)

(21) Appl. No.: 14/587,333

(22) Filed: Dec. 31, 2014

Related U.S. Application Data
(60) Provisional application No. 61/974,730, filed on Apr. 3, 2014.

(51) Int. Cl. H04L 12/24; G06Q 20/14; H04L 29/06

(52) U.S. Cl. CPC H04L 41/5054; H04L 63/08; H04L 63/102; G06Q 20/145; H04L 41/5051

(57) ABSTRACT

A system for nearly instantaneous service provisioning includes a customer premises pre-configured to receive one or more network services. The customer premises is coupled to a service edge device connecting the customer premises to a service provider network. The service edge device is configured to receive identifying credentials from the customer premises, and determine, via an authentication server, whether a walled garden flag has been set for the identifying credentials. In response to determining that a walled garden flag has been set, the service edge device configures a tunnel into a walled garden, and restricts access from the customer premises, wherein access is limited to the walled garden. In response to determining that a walled garden flag has not been set, the service edge device allows immediate access outside of the walled garden to receive the one or more network services.

### CROSS-REFERENCES TO RELATED APPLICATIONS

This application claims priority to U.S. Provisional Patent Application Ser. No. 61/974,730 (the “'730 application”), filed on Apr. 3, 2014 by Thomas Schwengler et al. (attorney docket no. 020370-016301US), entitled, “MDUlink: Bulk Provisioning of Broadband Service with Easy Customer Activation.”

This application is also related to U.S. patent application Ser. No. 14/519,970 (the “'970 application”), filed Oct. 21, 2014 by Michael L. Elford et al. (attorney docket no. 020370-014000US), entitled “Omedia Panel”, which claims priority from U.S. Provisional Patent Application Ser. No. 61/893,357, filed Oct. 21, 2013 by Michael L. Elford et al. (attorney docket no. 020370-014001US), entitled “Omedia Panel.”

The respective disclosures of these applications are incorporated herein by reference in their entireties and for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to provisioning broadband internet services, and more particularly to methods, systems, and computer software for instantly activating bulk provisioned broadband internet services in a multi-dwelling unit.

### BACKGROUND

Traditionally, the provisioning of broadband internet services requires a customer to contact an internet service provider with an order for broadband internet service. The internet service provider (ISP) then provides hardware and personnel, such as an installation technician, to connect a customer's premises to the ISP's network and equipment, and activate broadband internet service. Furthermore, the customer accesses the internet using a gateway device. Gateway devices are usually shipped to a customer by the ISP, or the customer may independently purchase such equipment. As such, the provisioning and activation of broadband internet services to a customer premises is a time and resource intensive process requiring the customer to contact the ISP, and the ISP to take some action to begin provisioning the broadband internet service.

Increasingly, broadband internet services may also be acquired over wireless access points, such as Wi-Fi hotspots, in public spaces and businesses. Wi-Fi hotspots allow devices or users, connected to the wireless access point, to purchase internet access from an internet service provider controlling Wi-Fi hotspot. Thereafter, an authorized device or user may connect to and access the internet from other Wi-Fi hotspots controlled by the internet service provider. Although Wi-Fi hotspots essentially provide on-demand access to the internet, service is limited to areas associated with the Wi-Fi hotspots and the internet must be accessed through the associated wireless access points. Moreover, the authorization of internet access through Wi-Fi hotspots involves fundamentally different network infrastructure and access architectures than those involved in the provisioning of broadband internet services to customer premises.

Hence, there is a need for a solution to provision broadband internet services to customer premises in a near-instantaneous manner, while avoiding the need for ISP action in each instance of broadband internet service activation.

### BRIEF SUMMARY

According to a set of embodiments, a system for the nearly instantaneous provisioning of broadband internet services is provided.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a system may be implemented for the nearly instantaneous provisioning of network services. For example, network services may include, among others, broadband internet service, television service, voice service, or the like. The system may include a customer premises pre-configured to receive one or more network services, wherein the customer premises is assigned identifying credentials that uniquely identify the customer premises. The system may further include a service edge device in communication with the customer premises, where the service edge device is configured to connect the customer premises to a service provider network.

The service edge device may further comprise at least one processor, and non-transitory computer readable media having encoded thereon computer software comprising a set of instructions executable by one or more computers to perform one or more operations. In some embodiments, the set of instructions may include: instructions to receive, from the customer premises, identifying credentials; instructions to authenticate, via an authentication server, the identifying credentials; instructions to, upon authenticating the identifying credentials, determine, via the authentication server, whether a walled garden flag has been set for the identifying credentials; instructions to establish, in response to determining that the walled garden flag has been set, a tunnel into a walled garden; instructions to restrict, in response to determining that the walled garden flag has been set, access from the customer premises, wherein access is limited to the walled garden; and instructions to allow, in response to determining that a walled garden flag has not been set, immediate access outside of the walled garden to receive the one or more network services.

According to some embodiments, the system may further include a captive portal server in communication with the service edge device. The captive portal server may be operable to provide walled garden portal to the customer premises via the tunnel. The walled garden portal may include an interface to receive a customer selection of one or more offers to purchase at least one of the one or more network services, as well as customer payment information. In response to receiving the customer selection and customer payment information, the captive portal server may remove the walled garden flag from the identifying credentials.

In another aspect, a service provisioning device may be implemented for the near-instantaneous provisioning of network services. The device may be a device in communication with a customer premises and may include at least one processor, and non-transitory computer readable media having encoded thereon computer software comprising a set of instructions executable by one or more computers to perform one or more operations.

The set of instructions may include: instructions to receive, from a customer premises, identifying credentials; instructions to authenticate, via an authentication server, the identifying credentials; instructions to, upon authenticating the identifying credentials, determine, via the authentication server, whether the a walled garden flag has been set for the identifying credentials; instructions to establish, in response to determining that a walled garden flag has been set, a tunnel into a walled garden; instructions to restrict, in response to determining that the walled garden flag has been set, access from the customer premises, wherein access is limited to the walled garden; and instructions to allow, in response to determining that a walled garden flag has not been set, immediate access outside of the walled garden to receive the one or more network services.

In various embodiments, the set of instructions may further include instructions to redirect, via the tunnel, traffic from the customer premises to a captive portal server, and instructions to provide, via captive portal server, a walled garden portal, hosted on the captive portal server, to the customer premises.

In some embodiments, the device may include instructions to receive, via the walled garden portal, a customer selection of one or more offers to purchase at least one of the one or more network services, and instructions to receive, via the walled garden portal, customer payment information. In further embodiments, the device may further include instructions to remove the walled garden flag from the identifying credential, in response to receiving the customer payment information.

In yet another aspect, a method may be implemented for provisioning services in a nearly instantaneous manner. The method may include provisioning, in bulk, network connectivity between at least one customer premises and a service provider network, assigning unique identifying credentials to each of the at least one customer premises, adding a walled garden flag to each of the identifying credentials, establishing, via the service edge device, communications with the customer premises, and receiving, via the service edge device, identifying credentials from customer premises. The method may further include, determining, via an authentication server, whether a walled garden flag has been set for the identifying credentials, establishing, via the service edge device, in response to determining that the walled garden flag has been set, a tunnel into a walled garden, restricting, via the service edge device, in response to determining that the walled garden flag has been set, access from the at least one customer premises, wherein access is limited to the walled garden, and allowing, via the service edge device, in response to determining that the walled garden flag has not been set, immediate access outside of the walled garden to receive the one or more network services.

According to some embodiments, the method may further include redirecting, via the service edge device, all traffic from the customer premises to a captive portal server, providing, via the captive portal server, a walled garden portal, wherein the walled garden portal comprises one or more offers to provide at least one network service, receiving, via the walled garden portal, a customer selection of the at least one network service, and receiving, via the walled garden portal, customer payment information. In response to receiving the customer payment information, in various embodiments, the method may also include removing the walled garden flag from the identifying credentials.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram of a system for near-instantaneous provisioning of network services before broadband internet services are activated, in accordance with various embodiments.

FIG. 2 is a block diagram of a system for near-instantaneous provisioning of network services as restricted to a captive portal, in accordance with various embodiments.

FIG. 3 is a block diagram of a system for near-instantaneous provisioning of network services after broadband internet services are activated, in accordance with various embodiments.

FIG. 4 is a block diagram of a system for bulk provisioning broadband access to customer premises as part of a system for near-instantaneous provisioning of broadband internet services, in accordance with various embodiments.

FIG. 5 is a block diagram of an architecture for multiple multi-dwelling units, in accordance with various embodiments.

FIG. 6 is a flow diagram of a method for the bulk provisioning of customer premises for near-instantaneous provisioning of network services, in accordance with various embodiments.

FIG. 7A is a flow diagram of a method for near-instantaneous provisioning of network services, in accordance with various embodiments.

FIG. 7B is a flow diagram of a method for the receiving and configuring of a customer order for near-instantaneous provisioning of network services, in accordance with various embodiments.

FIG. 8 is a flow diagram of a method for cancelling a network services in a near-instantaneous provisioning system, in accordance with various embodiments.

FIG. 9 is a block diagram of an exemplary computer architecture for the near-instantaneous provisioning of network services, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

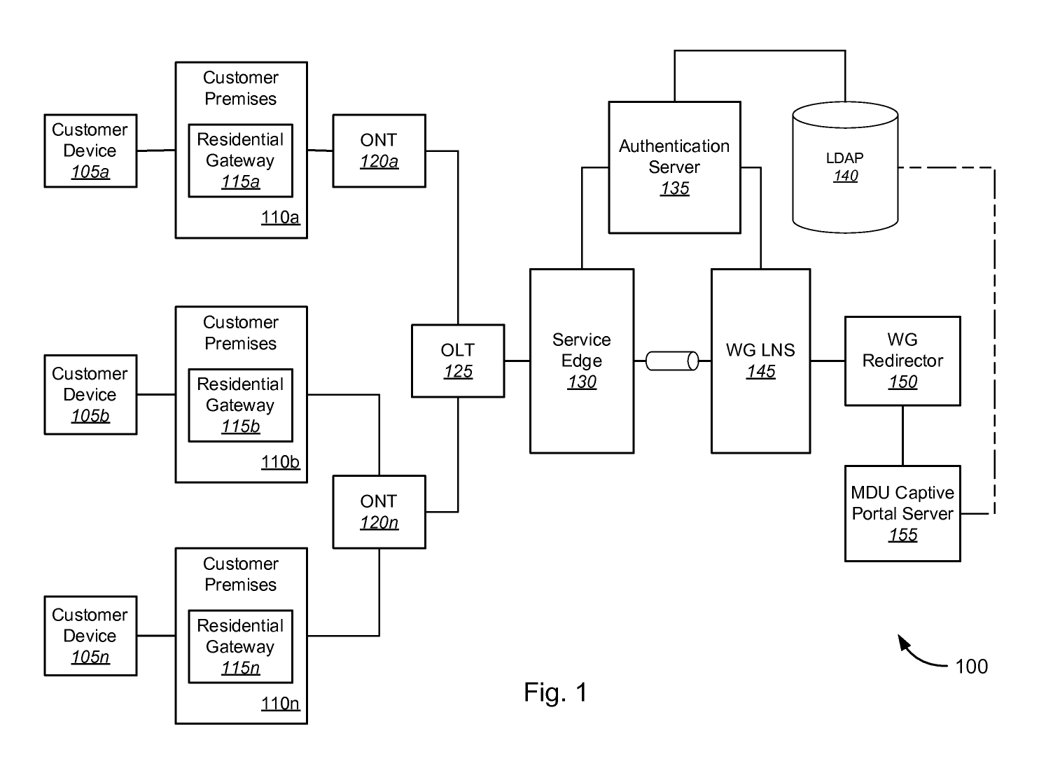

The accompanying descriptions of FIGS. 1-9 are provided for purposes of illustration and should not be considered to limit the scope of the different embodiments. FIGS. 1-4 illustrate different aspects of a system for near-instantaneous provisioning of broadband internet services. FIGS. 1-9 may refer to examples of different embodiments corresponding various stages and components of the provisioning system, which can be considered alternatives or which can be used in conjunction with one another in the various embodiments.

FIG. 1 is a block diagram of a system 100 for near-instantaneous provisioning of network services, in accordance with various embodiments. The various hardware and network elements depicted correspond to the system 100 before broadband internet services are activated for customer premises 110. In various embodiments, the system 100 may be utilized to provision, in a near-instantaneous manner, a customer order for various network services. Network services may include, without limitation, broadband internet services, television service, and voice/telephone service. The system 100 includes a plurality of customer devices 105a, 105b, 105n (105 collectively) connected to a respective customer premises 110a, 110b, 110n (110 collectively). Each customer premises 110 includes a respective residential gateway 115a, 115b, 115n (115 collectively). In this manner, each of the customer devices 105 is coupled respectively to a residential gateway 115. According to one set of embodiments, each customer premises 110 is an individual dwelling unit within a multi-dwelling unit (MDU) comprising a plurality dwelling units, where each customer premises 110 has a respective residential gateway 115. In alternative embodiments, the customer premises 110 may include, without limitation, houses, townhomes, duplexes, and other residential or commercial buildings and spaces. Each physical unit associated with the customer premises 110, whether a house or an individual dwelling unit of an MDU, may be referred to generically as a living unit (LU).

In various embodiments, the residential gateways 115 may be physically integrated into the customer premises 110. For example, each customer premises may respectively include an Omedia panel, as described in the '970 application. The residential gateway 115 may include either wired or wireless connectivity. In various other embodiments, the customer premises 110 may not include a separate residential gateway 115 altogether. Instead, the customer premises 110 may be wired and configured such that a customer device 105 may connect directly through a physical wired connection, or wirelessly, to the customer premises 110 directly. Thus, the customer premises may itself function like a “pseudo” residential gateway, without the need for residential gateway equipment.

In other embodiments, the customer premises may not have any additional or “smart” functionality, and instead simply provide a direct connection, from the customer premises to downstream network edge device. For example, as depicted, network edge devices may include, without limitation, an optical network terminal (ONT). Each of the customer premises 110 may be individually connected to a respective ONT 120a, or to an ONT shared between multiple customer premises 120n. According to one set of embodiments, each of the ONTs may further be connected to an optical line termination (OLT) 125. The OLT 125 acts as the interface between the optical network and the service provider's core network. OLT 125 is in turn coupled to a service edge device 130 of the ISP core network. In other embodiments, the ONT, or other combination of ONT and OLT may be utilized to communicate with the service edge device 130. In various embodiments, the service edge device 130 may include, without limitation, a broadband remote access server (BRAS), broadband network gateway (BNG), or other edge device. In other embodiments, different network edge devices may be substituted in place of an ONT as appropriate, as will be appreciated by those having skill in the art.

The service edge device 130 is configured to communicate with an authentication server 135, and to pass communications to and from a walled garden (WG) layer 2 tunneling protocol network server (LNS) 145 based on a determination by the authentication server 135. The authentication server 135 is communicatively coupled to a lightweight directory access protocol (LDAP) database 140. In one set of embodiments, the authentication server 135 may include, without limitation, a remote authentication dial-in user service (RADIUS) system, or a terminal access controller access-control system (TACACS). It will be appreciated by those skilled in the art that other authentication systems may be utilized that are capable of authenticating access to the ISP network by customer devices 105 connected to the respective residential gateways 115, and that authentication servers are not limited to RADIUS or TACACS based systems.

In various embodiments, the authentication server 135 receives a set of identifying credentials, authenticates the identifying credentials, and queries the identifying credentials against an LDAP database 140. In some embodiments, the identifying credentials may include point-to-point protocol (PPP) credentials that are unique to each respective residential gateway 115 of each of the customer premises 110. PPP credentials may include, without limitation, a username and password. In further embodiments, the identifying credentials may also include further identifying information common to multiple customer premises 110. Thus, the identifying credentials uniquely identify each living unit as distinct customer premises 110, and may further indicate further identifying information that may be used to commonly identify one or more customer premises 110 together as related by the further identifying information.

The identifying credentials are authenticated by the authentication server 135, and queried against an LDAP database 140. In one set of embodiments, the authentication server 135 may authenticate the identifying credentials internally against a locally stored database file. In another set of embodiments, the authentication server 135 may authenticate the identifying credentials against an external LDAP database 140. In various embodiments, the LDAP database 140 may include additional information related to the identifying credentials, including but not limited to, network address, phone number, account information, and access to specific network services. Thus, the LDAP database 140 may indicate that the identifying credentials have been flagged, for example, with a WG flag, and has a WG attribute added to the identifying credentials. This additional information, stored in the LDAP database 140, indicates that access to network resources has been limited to a WG, and that network traffic coming from the associated customer premises 110 is restricted to the WG.

Connectivity from the various customer premises 110 to the ISP network is authorized based on the authentication of the identifying credentials. In various embodiments, each of the customer premises 110a-110n have identifying credentials flagged to have access restricted to a walled-garden via the WG LNS 145. Therefore, in response to the identifying credential being flagged for WG redirect, in various embodiments, the service edge device 130 establishes a layer 2 tunneling protocol (L2TP) tunnel to the WG LNS 145, and an L2TP session is initiated. The WG LNS 145 is communicatively coupled to a WG redirector 150. The WG redirector 150 directs traffic from the customer premises 110 to an MDU captive portal server 155. The captive portal server 155 may also be communicatively coupled to the LDAP database 140. The captive portal server 155 hosts the MDU walled garden.

In various embodiments, the MDU walled garden may include a WG portal in the form of a service activation portal. The service activation portal may be present, to a customer on their customer device 105, configuration options for the customer to configure their services, as well as an interface to receive payment information from the customer. Configuration options may include, without limitation, selecting internet, television, or phone services, internet speed, television channels, or other related services offered over the service provider network. For example, in one set of embodiments, the service activation portal may present the customer with service offers for various service speeds at different price points, such as 40 megabits per second (mbps) for $29.95 per month, 100 mbps for $49.95 per month, 500 mbps for $59.95 per month, and 1 gbps for $69.95 per month. The customer may then select their desired speed of service based on these options. In further embodiments, television or voice service offerings may also be available for activation through the service activation portal.

Upon receiving payment information, the captive portal server 155 may communicate the selection of configuration options to a server hosting the LDAP 140 database, or the captive portal server 155 may update the LDAP database 140 itself. In various embodiments, the captive portal server 155 may be a revenue extraction gateway (RXG) or other similar device. Based on the updates to the LDAP database 140 indicating the configuration options selected, the authentication server 135 may then indicate to the service edge device 130 whether, based on the identifying credentials, customer devices 105 connected to the customer premises 110 are allowed to access one or more network services on the ISP network.

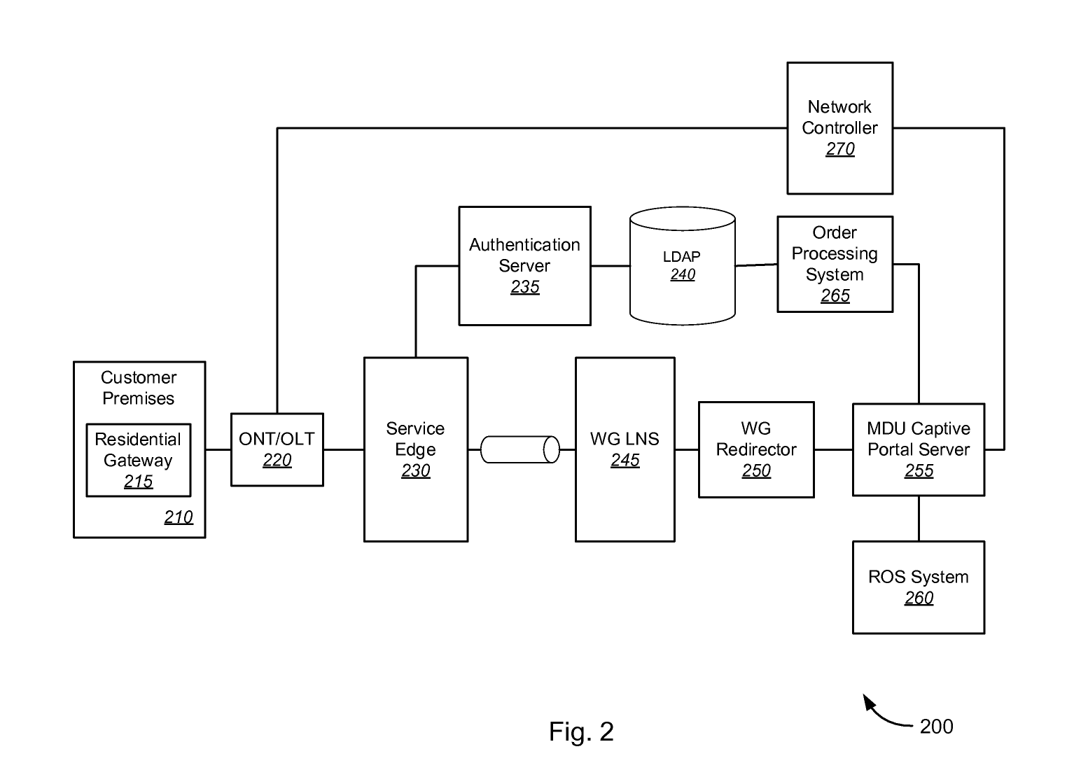

For example, FIG. 2 illustrates a system 200 for near-instantaneous provisioning of network services according to a customer order, in accordance with various embodiments. The system 200 includes customer premises 210 having a residential gateway 215, through which a customer accesses a service activation portal hosted on MDU captive portal server 255. As described above with respect to claim 1, the residential gateway 215 is coupled to an ONT and/or OLT 220, which is in turn coupled to a service edge device 230. The service edge device 230 establishes an L2TP tunnel to WG LNS 245. The WG LNS 245 forwards traffic to a WG redirector 250 that routes traffic to the MDU captive portal server 255. From a service activation portal hosted by the MDU captive portal server 255, a customer is able to select and order various network services offered by the ISP, including internet, voice, and television services.

In various embodiments, upon receiving the customer's selection and payment information, the MDU captive portal server 255 may query a real-time open sessions (ROS) system 260 to retrieve the identifying credentials of the customer premises associated with the order. In some embodiments, the MDU captive portal server 255 may retrieve a set of identifying credentials, as discussed above with respect to FIG. 1, which includes, but is not limited to, a set of PPP credentials. The MDU captive portal server 255 may then cause an order processing system 265 to remove any WG flags attributed to the identifying credential from the LDAP database 240, allowing the full internet access from the customer premises 210. In various embodiments, the order processing system 265 may comprise an Improv web service for the creation and management of identifying credentials. Thus, in some embodiments, the MDU captive portal server 255 may interface with the LDAP database 240 via the Improv web service to update and/or remove the WG attribute associated with the identifying credential.

Once identifying credentials have their WG flags removed by removing the WG attribute from the identifying credentials, all network traffic is allowed, and connections from the customer premises 210 and/or associated ONT/OLT 220 are no longer redirected by the service edge device to the MDU captive portal server 255.

For example, in one set of embodiments, when the authentication server 235 receives the set of identifying credentials after an order and compares them against the LDAP database 240, the identifying credential will not be flagged for redirect to the WG. Thus, connectivity from the customer premises 210 to the ISP network is no longer restricted to the WG by the service edge device 230, and full traffic is granted to the customer premises 210. In various embodiments, the ONT/OLT 220 may service multiple living units in an MDU. Thus, an ONT/OLT 220 may comprise a plurality of ports, and each port of the ONT/OLT 220 may correspond in a one-to-one configuration to a respective living unit of the MDU. Thus, when a flag is removed from an identifying credential, traffic to the port associated with that identifying credential of the ONT/OLT 220 may have full traffic allowed, while the other ports servicing customer premises that have yet to place an order will still have identifying credentials flagged for redirect to the walled garden.

According to various embodiments, WG flagging may involve either the activation or removal of a walled garden attribute from an identifying credential. For example, in one set of embodiments, a call may be made to an Improv web service of the order processing system 265, from a system within the ISP network firewall. To take a customer out of the WG, the following may be made to the Improv web server:

https://www.oss.centurylink.net/cgi-bin/improv/walled_garden/index.cgi?method=DeleteByWTN&wtn={0}&service=DSL&walledGarden={1}

where {0}=the customer's working phone number; and {1}=the WG instance/reason (e.g. InstaLink/Portal).

For example, the following call will flag a residential gateway 215 associated with an identifying credential in the form of a phone number “555-555-1212” of the residential gateway 215, into the MDU WG. In other words, it sets a WG attribute, in this example called the “mylmprov Walled-Garden” attribute to “InstaLink/Portal.”

https://www.oss.centurylink.net/cgi-bin/improv/walled_garden/index.cgi?method=DeleteByWTN&wtn=5555551212&service=DSL&walledGarden=InstaLink/Portal

In this case, {0} has been replaced by the customer phone number 555-555-1212, and {1} specifies the WG attribute as InstaLink/Portal.

The following call will take the residential gateway having the phone number “555-555-1212” out of the MDU WG. In other words, it sets the mylmprov Walled-Garden attribute to “ ”, (i.e. NULL).

https://www.oss.centurylink.net/cgi-bin/improv/walled_garden/index.cgi?method=DeleteByWTN&wtn=6514839593&service=DSL&walledGarden=

Thus, in this case, {0} remains the customer phone number 555-555-1212, and {1} is left blank, signifying a null condition.

In some embodiments, given an internet protocol (IP) address, the ROS system 260 can provide the customer's working telephone number (WTN) and/or PPP credentials. Alternatively, a method for deleting or adding a WG flag based on an IP address or PPP credentials directly.

In an alternative set of embodiments, a call to activate or remove a walled garden attribute from an identifying credential may be placed from outside of the ISP network firewall. In this scenario, certain white-listed servers will be able to make calls like the following to activate/remove the WG attribute.

For example, the following call will put “CLIENT-PPPID” in the InstaLink/Portal WG:

https://www.centurylink.net/mdulink/?method=Add&uid=CLIENT-PPPID

The following call will take “CLIENT-PPPID” out of the InstaLink/Portal WG:

https://www.centurylink.net/mdulink/?method=Del&uid=CLIENT-PPPID

In various embodiments, the ISP may keep a record of PPPIDs (i.e. PPP credentials) of which the WG attribute may be changed in the above manner, by a white-listed server from outside of the ISP network firewall.

In further embodiments, the MDU captive portal server 255 may also generate a new business as usual (BAU) service order in response to the customer's order and indicated selections. The BAU service order may be used by a network configuration manager (NCON) 270 to change at least one of a service speed, or service responsibility. For example, in various embodiments, each customer premises 210 may be provisioned to have the highest network speed. In some embodiments, the service speed may be enabled and controlled at each port of an ONT/OLT 220 individually. Thus, the ONT/OLT 220 may initially be enabled for the highest possible speed. In response to the customer placing an order selecting a speed less than the maximum speed, the MDU captive portal server 255 may generate a BAU service order indicating a speed less than the maximum speed. Thus, a request may be sent to the NCON 270, to lower the service speed to the respective customer premises 210. In various embodiments, this request may be based on the BAU service order. The NCON 270 may then change the service speed at the port of the ONT/OLT 220 associated with the customer premises 210. Thus, network services are provisioned to customer premises 210, according to a customer's selections, as received through the service activation portal.

According to some embodiments, a customer may place orders for network services on one or more of a prepaid, monthly service, annual service, contractual, or “pay-as-you-go” basis. When the customer cancels payments or services, the NCON 270 updates the ONT/OLT 220 and the MDU captive portal server 255 updates the LDAP 240 to reflect the cancellation. For example, in various embodiments, when the services are ended, the MDU captive portal server 255 instructs the order processing system 265 to re-flag the identifying credentials with a WG attribute (i.e. WG flag). Traffic from the customer premises 210 associated with the identifying credentials are then immediately redirected by the service edge 230 back to the WG. From the WG service activation portal, the customer may be prompted to renew services or to place a new order for services. In some embodiments, if the customer declines to renew services, an auto-configuration server (ACS) order may direct an ACS to reset the residential gateway 215 to a factory default settings. Resetting the residential gateway 215 to factory default settings may include, without limitation, reverting the login username, password, and service set identification (SSID) to factory defaults. The identifying credentials associated with the customer premises 210 may also be reset at the residential gateway 215. Furthermore, similar to how the NCON 270 adjusts the service speed at the ports of the ONT/OLT 220, a BAU service order is created to cause the NCON to reset the port of the ONT/OLT 220 associated with the customer, back to a default bulk provisioning status. In some embodiments, the default bulk provisioning status of the port may be to enable the highest possible speed for that port. Other ports of the ONT/OLT 220 may, however, remain unchanged, as they may correspond to other customer premises 210.

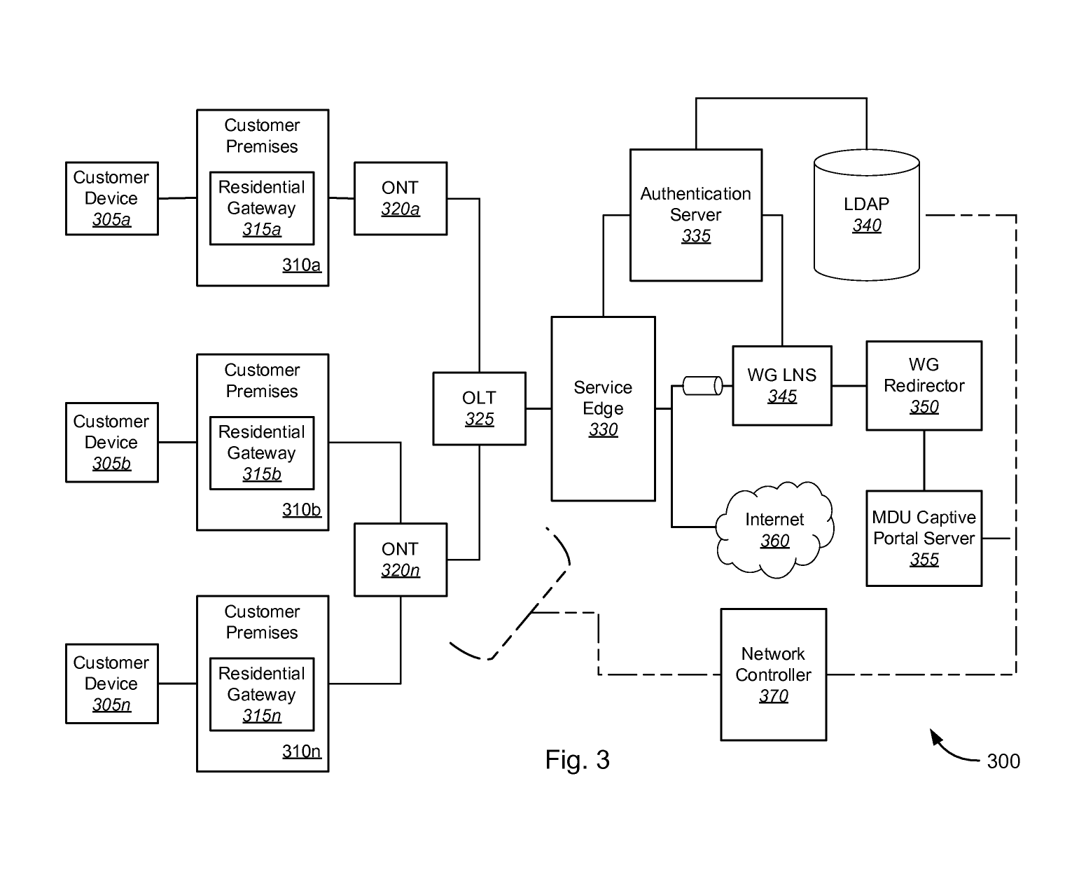

FIG. 3 illustrates a system 300 for near-instantaneous provisioning of network services on an individual customer premises basis, in accordance with various embodiments. Similar to FIG. 1, the system 300 includes a plurality of customer devices 305a, 305b, 305n (305 collectively) connected to a respective customer premises 310a, 310b, 310n (310 collectively). Each customer premises 310 includes a respective residential gateway 315a, 315b, 315n (315 collectively). As depicted, two of the customer premises 310b, 310n comprise an individual LU in an MDU, each respective residential gateway 315b, 315n coupled to an ONT 320n. Thus, each of the customer premises 310b, 310n are assigned a respective port on the ONT 320n. Customer premises 310a may have a residential gateway 315a coupled to its own ONT 320a associated with customer premises 310a. In various embodiments, customer premises 310a may be a house in a residential community. In some embodiments, the ONT 320a may be associated exclusively with customer premises 320a. In other embodiments, multiple homes in a neighborhood may share ONT 320a. Each of the ONTs 320a, 320n are coupled to OLT 325. OLT 325 provides a connection to a service edge device 330.

As customers move into and out of the various customer premises 310, the near-instantaneous service provisioning system must dynamically update the services to be provided to each of the customer premises 310. In various embodiments, one or more customer premises in an MDU may have activated broadband internet service while customers in other customer premises have not ordered broadband internet services.

For example, according to one set of embodiments, customer premises 310a and 310b may have placed orders for internet service through a service activation portal that is hosted on the MDU captive portal server 355. Customer premises 310n may not have placed an order to activate broadband internet service. Thus, when the customer premises 310a, 310b connect to service edge device 330, each of the residential gateways 315a, 315b pass on respective identifying credentials. As described with respect to FIGS. 1 & 2, the authentication server 335 receives a set of identifying credentials, authenticates the identifying credentials, and compares them against an LDAP database 340. In various embodiments, the LDAP database 340 may include additional information related to the identifying credentials, including but not limited to, network address, phone number, account information, and access to specific network services. The LDAP database 340 may contain a flag associated with the identifying credential indicating that network traffic coming from the associated customer premises 310 are restricted to a WG. The identifying credentials for the residential gateways 315a, 315b belonging to customer premises 310a, 310b have WG flags removed in response to their successful orders for broadband internet service. Thus, the identifying credentials no longer flagged for redirection to the WG, and instead are allowed by service edge device 330 to connect to the internet 360. Thus, full traffic is allowed to and from the customer premises 310a, 310b, based on the identifying credentials not having a WG attribute or WG flag associated with it. Meanwhile, because no order for broadband internet service has been placed from customer premises 310n, the identifying credentials associated with residential gateway 315n are still flagged for WG redirection. Thus, customer devices 305n connecting to the ISP network from customer premises 310n will continue to be redirected to by the service edge 330, through a L2TP tunnel to WG LNS 345, WG redirector 350, to the MDU captive portal server 355.

The system 300 also works to configure the broadband internet services per the customer order. Upon receiving an order at MDU captive portal server 355, a NCON 370, variously coupled to ONT 320a, ONT 320n, and OLT 325, may configure the broadband internet services as purchased by each of the customer premises 310 on an individual basis. Continuing with the previous example, customer premises 310a may have ordered internet service at a service speed of 100 mbps, and customer premises 310b may have ordered internet service having a service speed of 40 mbps. In response to receiving the order, the NCON 370 may adjust the speed of the ports at each respective ONT 320a, 320n. For example, in some embodiments, the NCON 370 may adjust a port at ONT 320a corresponding to customer premises 310a, lowering the speed from a maximum possible speed to the purchased service speed, 100 mbps. Similarly, the NCON 370 may adjust the port at ONT 320n associated with customer premises 310b from the highest possible speed to the purchased service speed of 40 mbps, while leaving other ports on ONT 320n, such as the port associated with customer premises 310n unchanged. Thus, although the port associated with customer premises 310b may be limited to a speed of 40 mbps, the port associated with customer premises 310n may retain the highest possible speed, as traffic from that port is restricted to the WG. Alternatively, in some embodiments, the service speed to each of the customer premises 310 may be changed and/or restricted from the OLT 325.

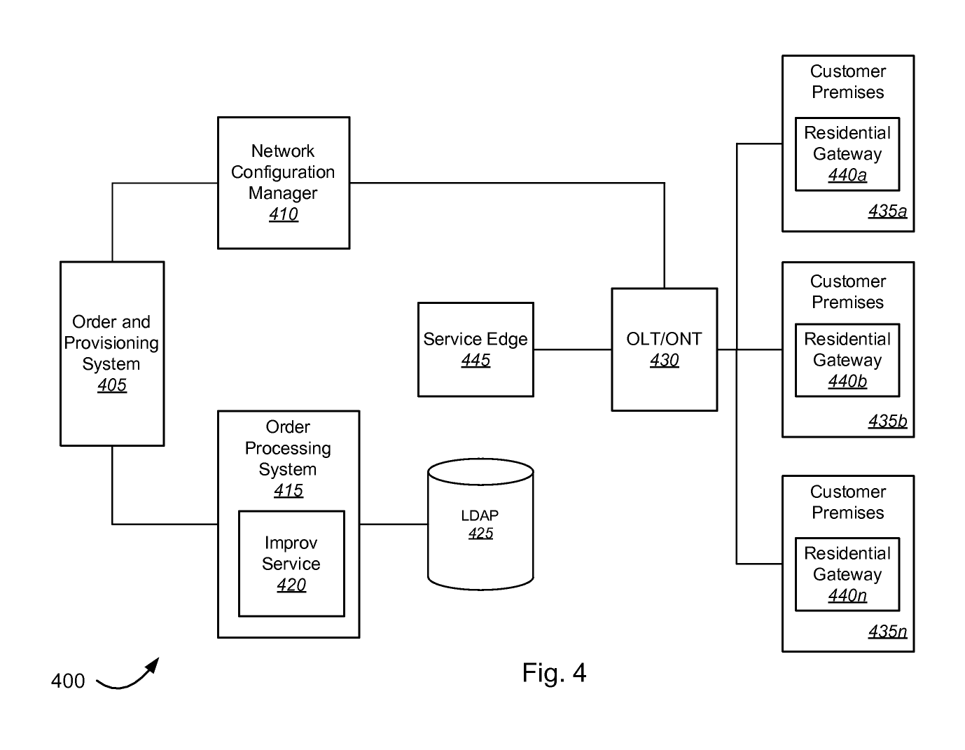

FIG. 4 illustrates the bulk provisioning of a system 400 for near-instantaneous provisioning of network services to a plurality of customer premises, in accordance with various embodiments. The system 400 includes an order and provisioning system 405 configured to initialize and provision network connectivity to each of the customer premises 435a, 435b, 435n (435 collectively), in bulk. In various embodiments, the bulk aspect of bulk provisioning may refer to the concurrent provisioning of connectivity to network services for a plurality of customer premises 440. The order and provisioning system 405 is coupled to an NCON 410, and an order processing system 415 comprising an Improv web service 420, the order processing system 415 in communication with LDAP database 425. The NCON 410 is coupled to an OLT/ONT 430, which is in turn couples each of the residential gateways 440a, 440b, 440n (440 collectively) of the customer premises 435 to a service edge device 445.

As described previously with respect to FIG. 1, each of the customer premises 435 include a respective residential gateway 440 integrated into each of the customer premises 435. Each of the respective residential gateways 440 are coupled to an ONT/OLT 430. In various embodiments, the ONT/OLT 430 may be provisioned as wired through, with optical cross-connects already placed, without the need for a technician or field engineer dispatch. Each of the ports of the ONT/OLT 430 may correspond in a one-to-one relationship to each customer premises 435. The installer or ISP may keep a list of LUs that comprise individual customer premises 435, and assign a respective identifying credential to each customer premises 435. The installer or ISP may enter the identifying credentials in the LDAP database 425 via the Improv web service 420. Thus, identifying credentials are created for each customer premises 435.

According to one set of embodiments, bulk service is initialized when a bulk order is created for all customer premises 435. The bulk service order is sent to the order and provisioning system 405, which requests network provisioning for each of the customer premises 435. The order and provisioning system 405 sends the request for network provisioning to the NCON 410. Bulk service is defined in the NCON 410, in a BAU manner. For example, in one set of embodiments, bulk service may be defined as a new speed, such as 999 Mbps, in a carrier-ethernet virtual local area network (CE-VLAN). Thus, the bulk service is defined at the NCON 410 and the ports of the OLT/ONT 430 associated with the customer premises 435 and are enabled for the highest speed for which the customer premises are provisioned (i.e. no restrictions placed on speed).

Each of the newly created identifying credentials has a WG flag set for them. For example, as described above with respect to FIG. 2, the Improv web service 420 may be used to activate a WG attribute for each of the identifying credentials associated with the customer premises 435. Furthermore, each of the residential gateways 440 are configured with their unique identifying credential. In various embodiments, a group of one or more identifying credentials of associated customer premises 435, such as LUs in an MDU, can be commonly identified by their identifying credentials. For example, identifying credentials may identify each of the customer premises 435a, 435b, 435n uniquely and individually, but each of identifying credentials may further include a realm identifier to identify each of the customer premises 435a, 435b, 435n as being part of the same MDU. In various embodiments, a specific MDU WG portal instance may be created for particular MDU realm credentials. Thus, as bulk provisioned, access from the customer premises 435 are pre-configured to be restricted to a WG instance, such as a service activation portal, specific to the particular customer premises 435.

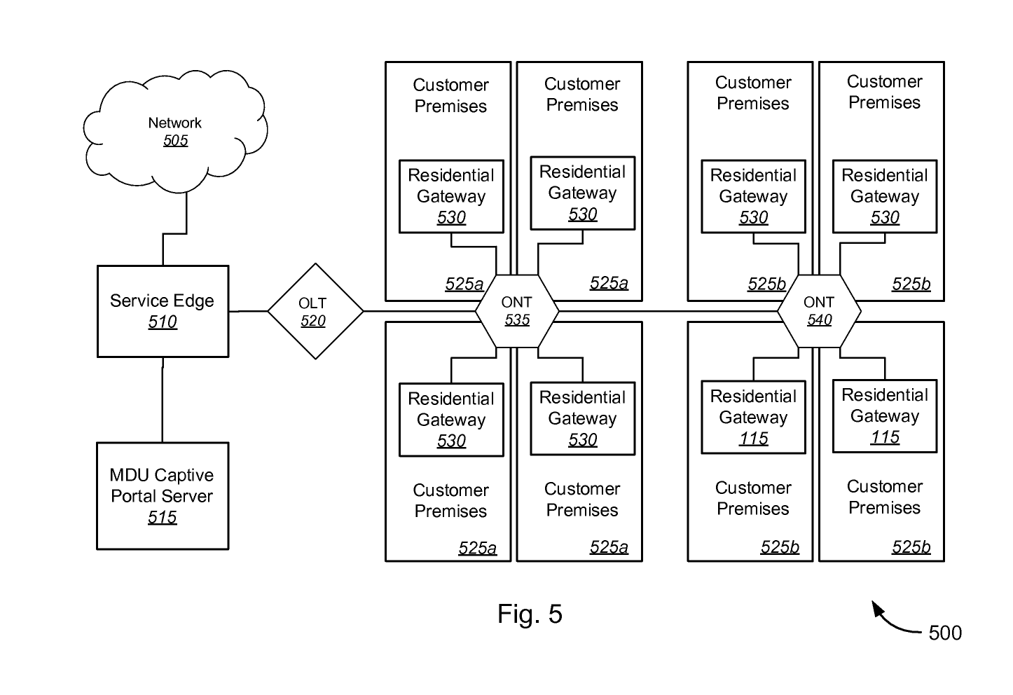

FIG. 5 is a block diagram of a system architecture 500 for near-instantaneous provisioning of network services, according to various embodiments. The system architecture 500 includes two ONTs 535, 540 coupled respectively to four customer premises 525a, 525b (525 collectively) each. Each of the ONTs 535, 540 are 4-to-1 ONTs, shared between the living units 525, each of the ONTs 535, 540 further coupled to OLT 520. OLT 520 couples each of the ONTs 535, 540 to a service edge device 510. The service edge device 510 is configured to connect each of the customer premises 525 to either the MDU captive portal server 515, or a network 505, such as an ISP network, the internet, or other network.

In various embodiments, wiring between the OLT 520, and ONTs 535, 540 may include optical fiber connections, while connections between each ONT 535, 540 to the respective residential gateway 530 may include Ethernet connections utilizing Cat 5e, Cat 6, or other cables capable of Ethernet communications. The OLT 520 may be connected to the service edge device 510 via an optical fiber connection, while the service edge 510 may have an Ethernet connection to the MDU captive portal server 515.

Data services are provided on one unique virtual local area network (VLAN) for all data customers in a given MDU. Each residential gateway 530 is assigned a temporary private IP address from a dynamic host configuration protocol (DHCP) server of the MDU captive portal server 515. Each ONT 535, 540 is set to force forward migration authorization code (MAC) requests, which isolates each customer premises 525.

In various embodiments, the MDU captive portal server 515 may have a pool of VLANs for use with specific MDUs. The MDU captive portal server 515 thus assigns a VLAN to the customer premises 525 at sign-in, based on a dynamically assigned identifier, such as the IP address of the active session, as distinct from the use of an identifying credential by the service edge device 510, which is used to forward traffic from the residential gateway 530 to either the MDU captive portal server 515 in the first place, or to allow full traffic from the residential gateway 530 via network 505. In one set of embodiments, the dynamically assigned identifier may change or be re-assigned any time a new session is created, or every time a customer re-connects to the MDU captive portal server 515 through the customer premises 525. In various embodiments, the MDU captive portal server 515 may trigger process to place BAU orders for network service provisioning, as customer orders are received through a service activation portal.

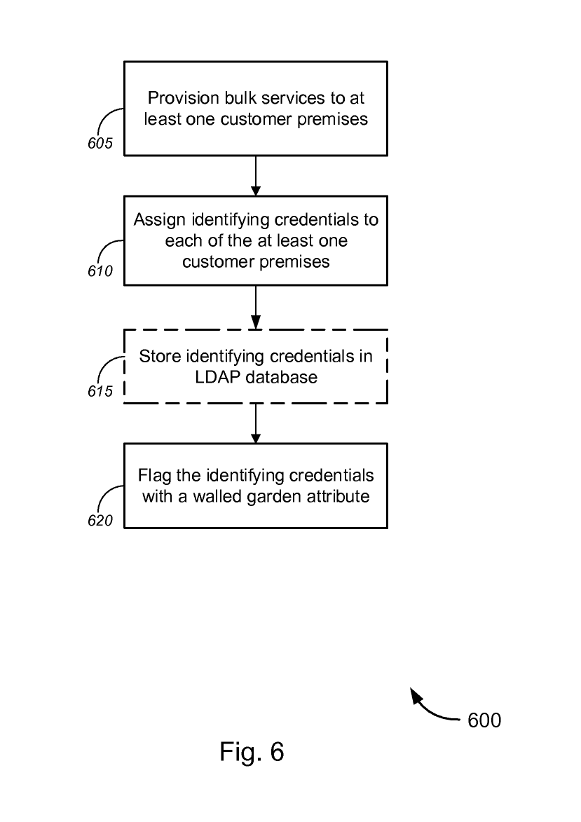

FIG. 6 is a flow diagram of a method 600 for bulk provisioning customer premises for near-instantaneous provisioning of network services, in accordance with various embodiments. At block 605, bulk services may be provisioned to at least one customer premises pre-configured to comprise a residential gateway, as described above with respect to FIGS. 1 & 4. In various embodiments, the residential gateway may be physically integrated into the customer premises so as to form a permanent part of the customer premises. In various embodiments, the customer premises are wired for, effectively, direct connection from the customer premises to an ONT or OLT device. According to one set of embodiments, bulk services may be provisioned to a plurality of customer premises, comprising individual living units of an MDU. In another set of embodiments, bulk services may be provisioned to a residential development comprising a plurality of houses, townhomes, or other residential buildings in a neighborhood.

At block 610, each of the bulk provisioned customer premises are assigned a unique identifying credential. In various embodiments, each living unit of the MDU comprising a separate customer premises, is assigned an identifying credential to uniquely identify each LU individually. In some embodiments, the identifying credentials may include further identifying information that may be used to commonly identify a group of customer premises, for example, all customer premises within the same MDU. Thus, further identifying information may be used to distinguish between multiple MDUs. Further identifying information may also be used to indicate a geographic location, different tiers of markets, pricing schemes to be applied, subgroups within groups of customer premises, or otherwise further identify a grouping of more than one customer premises.

At optional block 615, the identifying credentials created by the installer or ISP are stored within an LDAP database. In various embodiments, an Improv web service, as described above with respect to FIGS. 2 & 4, may be utilized to enter and manage identifying credentials. In other embodiments, as will be appreciated by one having skill in the art, the LDAP database may be substituted for another suitable database capable of storing and managing the identifying credentials for authentication purposes.

At block 620, each of the identifying credentials are flagged with a WG attribute. In various embodiments, the identifying credentials will have a WG attribute activated when they are first created and stored. The ISP or installer may use an Improv web service, as described with respect to the embodiments above, or other suitable means, to set a WG flag corresponding to each identifying credential, as a default state. Thus, devices connecting from the customer premises for the first time will all automatically be redirected to the WG.

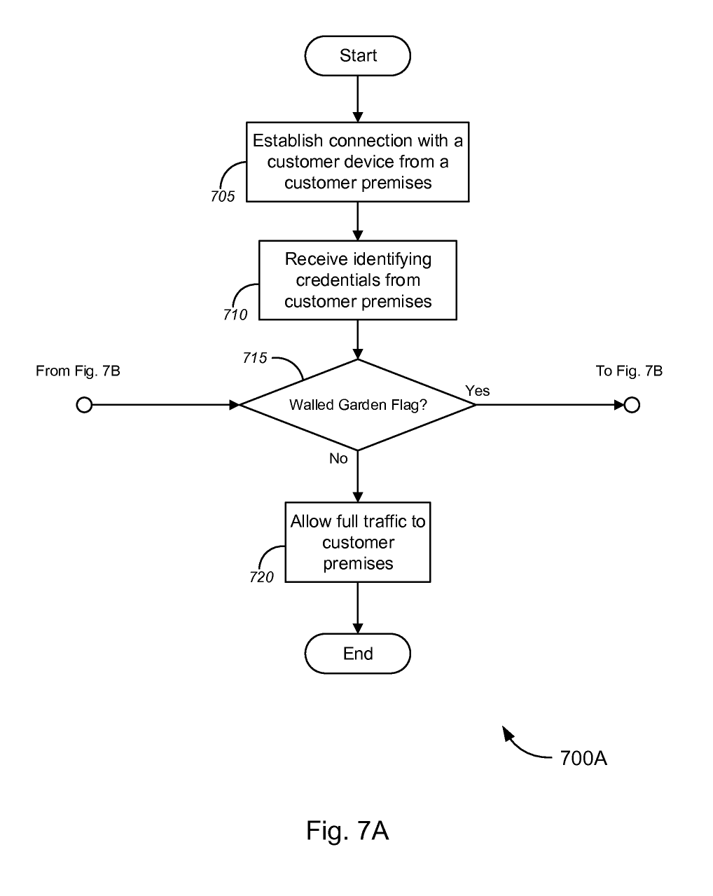

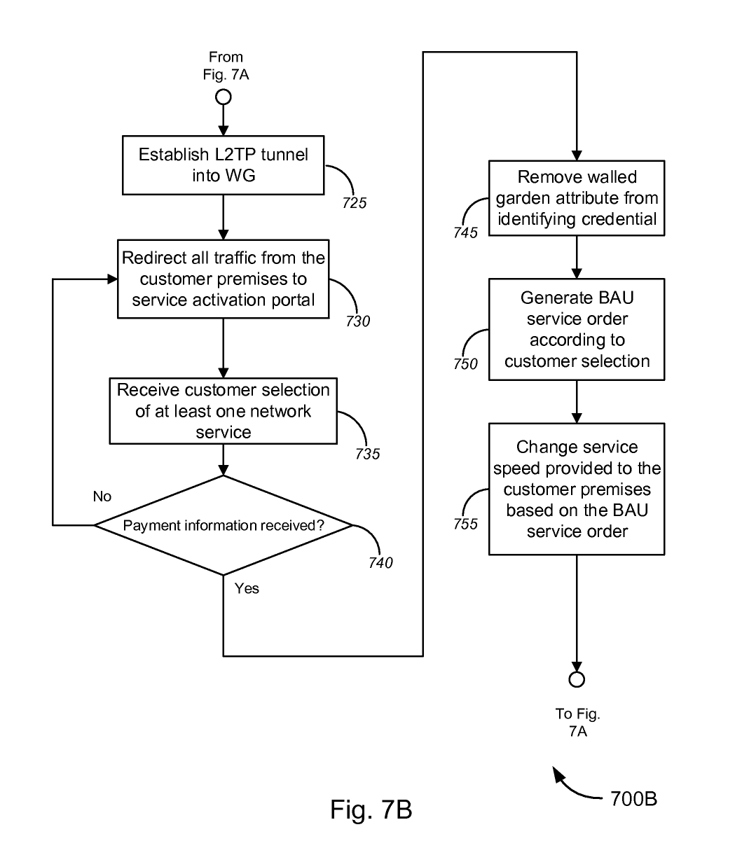

FIGS. 7A & 7B depict a flow diagram of a method 700A, 700B for the near-instantaneous provisioning of network services, in accordance with various embodiments. At block 705, a connection is established with a customer device on a customer premises. A service edge device may connect with a customer device via an ONT, OLT, or both, acting as an interface between the customer premises and the service edge device.

At block 710, identifying credentials are received, by the service edge device, from the customer premises. In various embodiments, the customer premises may comprise a residential gateway, having assigned identifying credentials that are input by a customer and transmitted to the service edge device.

At decision block 715, it is determined whether a WG flag has been set for the identifying credentials. In various embodiments, the service edge device may forward the identifying credentials to an authentication server to determine whether a WG flag has been set for the identifying credentials. According to one set of embodiments, the authentication server may authenticate the identifying credentials, for example by confirming a username and password combination, and query an authentication database for the received identifying credentials. The authentication database may be an external database, such as an LDAP database, and may comprise a table containing information about various identifying credentials, indicating whether or not the identifying credentials are flagged to be redirected to a walled garden. In another set of embodiments, the authentication database may be an internal database hosted locally on the authenticating server. In yet further devices, a local database on the service edge device itself may be used, with authentication occurring on the service edge device itself.

At block 720, if the identifying credentials do not have a WG attribute, and thus are not flagged with a WG flag, full traffic is allowed to and from the customer premises associated with the identifying credentials. However, if the identifying credentials do have a WG attribute, and thus are flagged with a WG flag, the method 700A proceeds, as depicted in FIG. 7B.

FIG. 7B is a flow diagram of a method 700B for receiving and provisioning a customer order, for the near-instantaneous provisioning of network services. At block 725, the service edge device establishes an L2TP tunnel into the WG.

At block 730, all traffic from the customer premises is redirected to a service activation portal of the WG. According to one set of embodiments, the service edge device connects to a WG LNS via the L2TP tunnel. The WG LNS is coupled to a WG redirector, which redirects traffic from the customer premises to a captive portal server. In various embodiments, a captive portal server may host various instances of service activation portals to be provided to the customer device, based on the IP address assigned to the customer premises for the active session, as distinct from the identifying credential. The service activation portal may include various configuration options for the customer to configure their network services, as well as an interface to receive payment information from the customer. In further embodiments, television or voice service offerings may also be available for activation through the service activation portal.

At block 735, a customer selection is received for at least one network service. For example, various configuration options corresponding to a respective network service may be transmitted. Configuration options may include, without limitation, selecting internet, television, or phone services, internet speed, television channels, or other related services offered over the service provider network. In one set of embodiments, the service activation portal may present the customer with service offers for various service speeds at different price points, such as 40 megabits per second (mbps) for $29.95 per month, 100 mbps for $49.95 per month, 500 mbps for $59.95 per month, and 1 gbps for $69.95 per month. The customer may then select their desired speed of service based on these options. In further embodiments, television or voice service offerings may also be available for activation through the service activation portal.

At decision block 740, it is determined whether payment information has been received for the customer's order. If payment information has not been received, traffic continues to be redirected to the service activation portal. However, if payment information has been received and payment is successful, at block 745, the walled garden attribute is removed from the identifying credential corresponding to the customer premises from which the customer order was placed. According to one set of embodiments, the captive portal server may query an ROS system to retrieve the identifying credentials of the customer premises associated with the order, based on the assigned IP address assigned to the residential gateway or customer premises. The captive portal server may then communicate an order to the Improv service to remove any WG flags attributed to the identifying credential from the LDAP or other authentication database.

At block 750, a BAU service order is generated, according to the customer order, including the customer selection of configuration options. In various embodiments, the BAU order may be created by the service activation portal application, or at a separate order processing system. The BAU order may then be forwarded to an NCON to indicate the changes to be made.

At block 755, changes are made to the service speed provided to the customer premises, based on the BAU service order. According to one set of embodiments, the BAU order may be processed by the NCON, which changes the service speed provisioned to the customer premises. For example, in various embodiments, each customer premises may initially be provisioned for a highest possible service speed. The service speed may be enabled and controlled at each port of an ONT or OLT individually, where each individual port of an ONT or OLT corresponds to a single customer premises. Thus, the ONT/OLT port may initially be enabled for the highest possible speed. In response to the customer placing an order selecting a speed less than the maximum speed, the captive portal server may generate a BAU service order indicating a speed less than the maximum speed.

The method 700B continues, at decision block 715 of FIG. 7A, where it is once again checked to see whether a WG flag has been set for the identifying credentials. The WG flag having been removed from the identifying credentials in response to the successful placement of an order, full traffic is allowed to the customer premises, at block 720, limited to the service speed selected in the customer order.

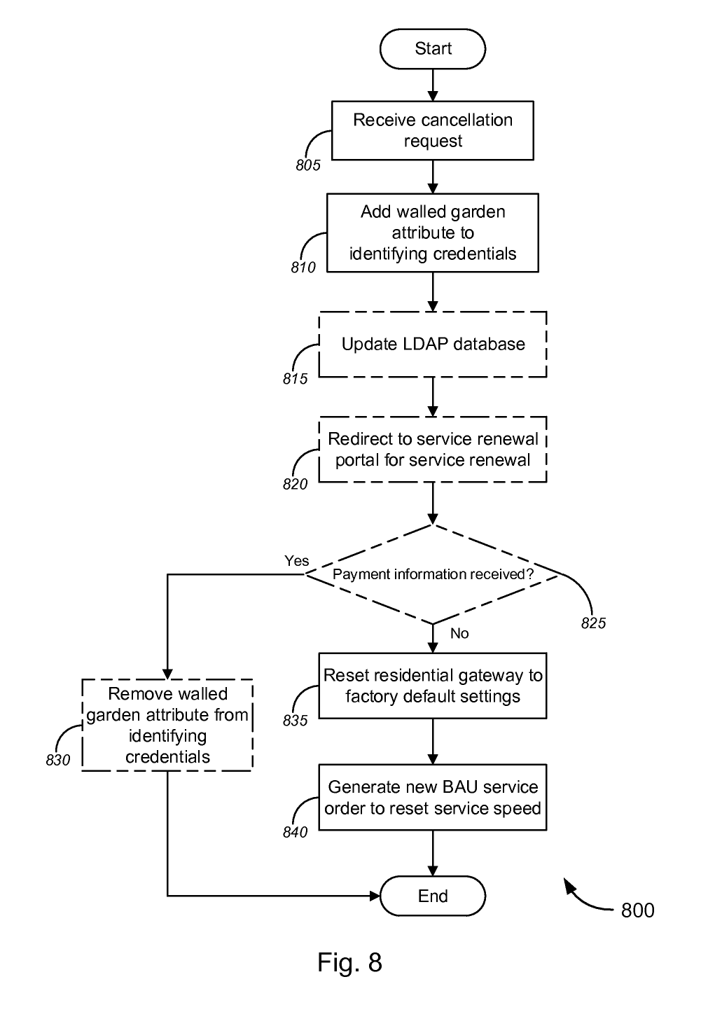

FIG. 8 is a flow diagram of a method 800 for cancelling services via the near-instantaneous provisioning system, in accordance with various embodiments. At block 805, a payment or service cancellation request is received. In various embodiments, depending on whether customers ordered services on a prepaid, monthly, annual, contractual, or “pay-as-you-go” basis, the customer may cancel payments, cease to make payments, or request to cancel services.

In response to receiving the payment or order cancellation request, at block 810, a walled garden attribute is added immediately back to the identifying credential. Thus, the identifying credentials are re-flagged with the WG flag, and all traffic from the customer premises will be redirected into the WG. At optional block 815, the authentication database, in the form of an LDAP database, is updated to reflect the changes to the identifying credentials. Additionally, at optional block 820, traffic from the customer premises may be redirected to a special service renewal portal within the WG. The service renewal portal may be hosted on a captive portal server that is provided to the customer similar to how a service activation portal is presented, as described with respect to previous embodiments. In various embodiments, the service renewal portal may offer the customer a way to renew services identical to their previous order, upgrade services, or make changes to their services. In some embodiments, the service renewal portal may present incentivized offers to the increase the likelihood of customer retention, such as, without limitation, reduced pricing, or providing additional services free of charge. In various embodiments, the service renewal portal may only be presented to customer premises having recently cancelled network services, and only temporarily for a period of time as determined by the ISP or installer.

At optional decision block 825, it is determined whether payment information is received for a renewal. If services are renewed, at optional block 830, the walled garden attribute is immediately removed from the identifying credentials, and the renewed order is configured in a BAU manner, similar to how services are activated for new customers through the service activation portal.

If services are not renewed and payment information is not received, or if a service renewal portal is not used, at block 835, the residential gateway associated with the cancelled order request is reset to factory default settings. In various embodiments, this may accomplished via an order to the ACS to reset the residential gateway. Factory default settings may include, without limitation, reverting one or more of a username, password, other login information, and SSID to factory defaults.

At block 840, a new BAU service order is also created to reset the service speed to the customer premises. In various embodiments, similar to how service speed is may be changed by the NCON according to the BAU service order, the NCON may restore a highest possible speed at a port of the ONT connected to the customer premises upon cancellation of the network services, and according to the BAU service order.

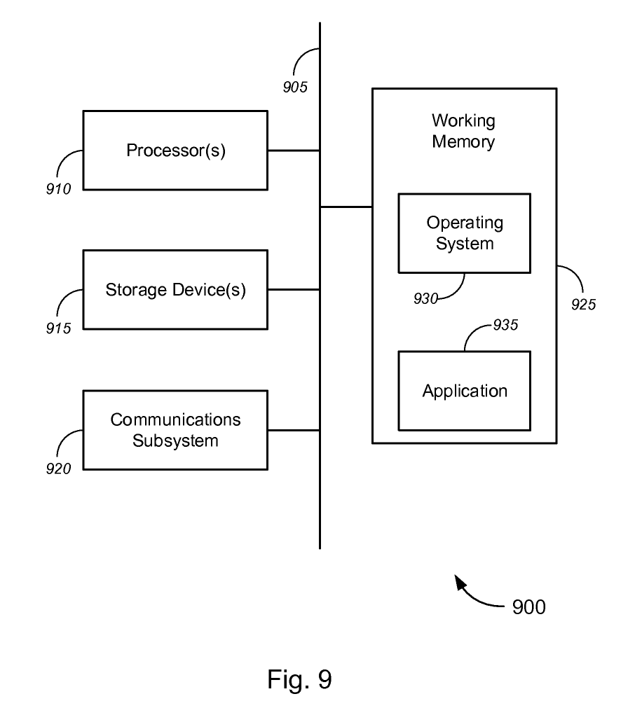

While the techniques and procedures in FIGS. 6, 7A, 7B, and 8 are depicted and/or described in a certain order for purposes of illustration, it should be appreciated that certain procedures may be reordered and/or omitted within the scope of various embodiments. Moreover, while the methods illustrated can be implemented by (and, in some cases, are described below with respect to) the systems 100, 200, 300, 400, 500, 900 of FIGS. 1, 2, 3, 5, and/or 9, respectively (or components thereof), such methods may also be implemented using any suitable hardware implementation. Similarly, while each of the system 100 (and/or components thereof) of FIG. 1, the system 200 (and/or components thereof) of FIG. 2, the system 300 (and/or components thereof) of FIG. 3, the system 500 (and/or components thereof) of FIG. 5, and/or the system 900 (and/or components thereof) of FIG. 9 can operate according to the methods illustrated above with respect to FIGS. 6, 7A, 7B, and 8 (e.g., by executing instructions embodied on a computer readable medium), the systems 100, 200, 300, 500, and/or 900 can each also operate according to other modes of operation and/or perform other suitable procedures.

FIG. 9 is a block diagram of an exemplary computer architecture that may be used for the near-instantaneous provisioning of network services, in accordance with various embodiments. FIG. 9 provides a schematic illustration of one embodiment of a computer system 900 that can perform the methods provided by various other embodiments, as described herein, and/or can perform the functions of the user devices, the service edge devices, authentication system, captive portal server, or any other computer systems as described above. It should be noted that FIG. 9 is meant only to provide a generalized illustration of various components, of which one or more (or none) of each may be utilized as appropriate. FIG. 9, therefore, broadly illustrates how individual system elements may be implemented in a relatively separated or integrated manner.

The computer system 900 includes a plurality of hardware elements that can be electrically coupled via a bus 905 (or may otherwise be in communication, as appropriate). The hardware elements may include one or more processors 910, including, without limitation, one or more general-purpose processors and/or one or more special-purpose processors (such as digital signal processing chips, graphics acceleration processors, and/or the like).

The computer system 900 may further include, or be in communication with, one or more storage devices 915. The one or more storage devices 915 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including, without limitation, various file systems, database structures, or the like.

The computer system 900 might also include a communications subsystem 920, which can include, without limitation, a modem, a network card (wireless or wired), a wireless programmable radio, or a wireless communication device. Wireless communication devices may further include, without limitation, a Bluetooth device, an 802.11 device, a WiFi device, a WiMax device, a WWAN device, cellular communication facilities, or the like. The communications subsystem 920 may permit data to be exchanged with a customer premises, residential gateway, integrated residential gateway, authentication server, walled garden, or combination of the above elements, as described above. Communications subsystem 920 may also permit data to be exchanged with other computer systems, and/or with any other devices described herein, or with any combination of network, systems, and devices. According to some embodiments, the network might include a local area network (“LAN”), including without limitation a fiber network, or an Ethernet network; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol, or any other wireless protocol; or any combination of these or other networks.

In many embodiments, the computer system 900 will further comprise a working memory 925, which can include a RAM or ROM device, as described above. The computer system 900 also may comprise software elements, shown as being currently located within the working memory 925, including an operating system 930, device drivers, executable libraries, and/or other code. The software elements may include one or more application programs 935, which may comprise computer programs provided by various embodiments, and/or may be designed to implement methods and/or configure systems provided by other embodiments, as described herein.

By way of example, one or more procedures described with respect to the methods discussed herein might be implemented as code and/or instructions executable by a computer (and/or a processor within a computer). In an aspect, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 915 described above. In some cases, the storage medium 915 might be incorporated within a computer system 900. In other embodiments, the storage medium might be separate from the computer system 900, in the form of a removable medium, such as an optical disc, USB flash drive, or the like. In some embodiments, the storage medium might be provided in an installation package, such that the storage medium can be used to program, configure, and/or adapt a general purpose computer with the instructions/code stored thereon. These instructions might take the form of executable code, which is executable by the processor(s) 900 and/or might take the form of source and/or installable code. The source or installable code, upon compilation, installation, or both compilation and installation, on the computer system 900 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, and/or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system 900 to perform methods in accordance with various embodiments of the invention. According to a set of embodiments, some or all of the procedures of such methods are performed by the computer system 900 in response to processor 910 executing one or more sequences of one or more instructions. The one or more instructions might be incorporated into the operating system 930 and/or other code that may be contained in working memory 925, such as an application program 935. Such instructions may be read into the working memory 925 from another computer readable medium, such as one or more of the storage device(s) 915. Merely by way of example, execution of the sequences of instructions contained in the working memory 925 might cause the processor(s) 910 to perform one or more procedures of the methods described herein.

The terms “machine readable medium” and “computer readable medium,” as used herein, refer to any medium that participates in providing data that causes a machine to operation in a specific fashion. In one set of embodiments, various computer readable media might be involved in providing instructions/code to processor(s) 910 for execution, might be used to store and/or carry such instructions/code such as signals, or both. In many implementations, a computer readable medium is a non-transitory, physical, and/or tangible storage medium. Such a medium may take many forms, including, but not limited to, non-volatile media, volatile media, and transmission media. Non-volatile media includes, for example, optical disks, magnetic disks, or both, such as the storage device(s) 915. Volatile media includes, without limitation, dynamic memory, such as the working memory 925. Transmission media includes, without limitation, coaxial cables, copper wire and fiber optics, including the wires that comprise the bus 905, as well as the various components of the communication subsystem 920, and/or the media by which the communications subsystem 920 provides communication with other devices. Hence, transmission media can also take the form of waves, including, without limitation, radio, acoustic, and/or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium; a RAM, a PROM, an EPROM, a FLASH-EPROM, or any other memory chip or cartridge; a carrier wave; or any other medium from which a computer can read instructions or code.

Various forms of computer readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 920 (and/or components thereof) generally will receive the signals, and the bus 905 then might carry the signals (and/or the data, instructions, etc. carried by the signals) to the working memory 925, from which the processor(s) 910 retrieves and executes the instructions. The instructions received by the working memory 925 may optionally be stored on a storage device 915 either before or after execution by the processor(s) 910.

According to a set of embodiments, the computer system 900 may establish a connection to an ONT or OLT to which a customer premises is connected. The connection may be a wired connection utilizing Ethernet, broadband cable, or optical fiber, or a wireless connection utilizing any of a WiFi, 3G, 4G, or other wireless data connection. Through the communications subsystem 920, the computer system 900 may be able to communicate with a customer premises to authenticate the identifying credentials of the customer premises, redirect traffic from the premises into a WG, and ultimately provision network services to the customer premises in a nearly-instantaneous manner. The computer system 900 might receive a set of identifying credentials associated with the customer premises, which it first authenticates, and subsequently determines whether or not a WG flag has been set for the customer premises. If the identifying credentials have a WG flag, traffic from the customer premises are redirected into a WG. In various embodiments, this may include establishing a L2TP tunnel into the WG. In one set of embodiments, the WG may comprise a WG portal, accessible via a captive portal server. The captive portal server may host a portal or web application for activating services, such as a service activation portal as previously described.

Upon the activation of services through the WG portal, the identifying credentials associated with the customer premises may have its WG flag removed. In various embodiments, this may include removing a WG attribute associated with the identifying credentials in a database, such as, without limitation, an LDAP database. Furthermore, a BAU service order may be created according to a customer order, and the connection from the customer premises may likewise configured by an NCON according to the BAU service order, as previously described. With the WG flag removed, the computer system 900 may now allow full traffic to be exchanged with the customer premises, without redirection to the WG.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture, but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system for nearly instantaneous network service provisioning comprising:
a customer premises pre-configured to receive one or more network services, wherein the customer premises is assigned identifying credentials that uniquely identify the customer premises;
a service edge device, in communication with the customer premises, the service edge device connecting the customer premises to a service provider network, the service edge device comprising:
at least one processor
non-transitory computer readable media having encoded thereon computer software comprising a set of instructions executable by the at least one processor to perform one or more operations, the set of instructions comprising:
instructions to receive, from the customer premises, identifying credentials;
instructions to authenticate, via an authentication server, the identifying credentials;
instructions to, upon authenticating the identifying credentials, determine, via the authentication server, whether a walled garden flag has been set for the identifying credentials;
instructions to establish, in response to determining that the walled garden flag has been set, a tunnel into a walled garden;
instructions to restrict, in response to determining that the walled garden flag has been set, access from the customer premises, wherein access is limited to the walled garden; and
instructions to allow, in response to determining that a walled garden flag has not been set, immediate access outside of the walled garden to receive the one or more network services.

2. The system of claim 1, further comprising a captive portal server in communication with the service edge device, the captive portal server providing a walled garden portal to the customer premises via the tunnel, wherein the walled garden portal comprises an interface to receive:
a customer selection of one or more offers to purchase at least one of the one or more network services; and
customer payment information;
wherein, in response to receiving the customer payment information, the captive portal server removes the walled garden flag from the identifying credentials.

3. The system of claim 2, wherein the captive portal comprises one or more portal instances, wherein the walled garden portal is selected from the one or more portal instances based on a dynamically assigned identifier distinct from the identifying credential.

4. The system of claim 2, further comprising a network configuration manager, wherein the network configuration manager adjusts at least a service speed provided to the customer premises, based on the customer selection.

5. The system of claim 1, wherein the service edge device and authentication server are the same device.

6. The system of claim 1, wherein the customer premises further comprises a residential gateway physically integrated into the customer premises, through which a customer device can connect to the service edge device.

7. The system of claim 1, wherein the customer premises is directly connected to a network edge device.

8. The system of claim 1, wherein the customer premises itself is operable as a residential gateway, wherein a customer device can connect, via the customer premises, to the service edge device.

9. The system of claim 1, wherein the service edge device is communicatively coupled to a multi-dwelling unit comprising a plurality of living units,
wherein the plurality of living units comprises the customer premises,
wherein the multi-dwelling unit comprises a network edge device that is communicatively coupled to the customer premises,
wherein the network edge device communicatively couples the customer premises to the service edge device, and
wherein the walled garden portal is operable to provision network service to each of the living units individually.

10. A near instantaneous service provisioning device, in communication with a customer premises, the near instantaneous service provisioning device comprising:
at least one processor
non-transitory computer readable media having encoded thereon computer software comprising a set of instructions executable by the at least one processor to perform one or more operations, the set of instructions comprising:
instructions to receive, from a customer premises, identifying credentials;
instructions to authenticate, via an authentication server, the identifying credentials;
instructions to, upon authenticating the identifying credentials, determine, via the authentication server, whether the a walled garden flag has been set for the identifying credentials;
instructions to establish, in response to determining that a walled garden flag has been set, a tunnel into a walled garden;
instructions to restrict, in response to determining that the walled garden flag has been set, access from the customer premises, wherein access is limited to the walled garden; and
instructions to allow, in response to determining that a walled garden flag has not been set, immediate access outside of the walled garden to receive the one or more network services.

11. The device of claim 10, wherein the set of instructions further comprise:
instructions to redirect, via the tunnel, traffic from the customer premises to a captive portal server;
instructions to provide, via captive portal server, a walled garden portal, hosted on the captive portal server, to the customer premises.

12. The device of claim 11, wherein the set of instructions further comprise:
instructions to receive, via the walled garden portal, a customer selection of one or more offers to purchase at least one of the one or more network services; and
instructions to receive, via the walled garden portal, customer payment information.

13. The device of claim 12, wherein the set of instructions further comprises instructions to adjusts, via a network configuration manager, at least a service speed provisioned to the customer premises, based on the customer selection.

14. The device of claim 12, wherein the set of instructions further comprise instructions to remove, in response to receiving the customer payment information, the walled garden flag from the identifying credential.

15. The device of claim 14, wherein the set of instructions further comprise instructions to re-flag the identifying credentials with the walled garden flag when network services to the customer premises are discontinued.

16. A method of provisioning services nearly instantaneously, the method comprising:
provisioning, in bulk, network connectivity between at least one customer premises and a service provider network;
assigning unique identifying credentials to each of the at least one customer premises;
adding a walled garden flag to each of the identifying credentials;
establishing, via the service edge device, communications with the customer premises;
receiving, via the service edge device, identifying credentials from customer premises;
determining, via an authentication server, whether a walled garden flag has been set for the identifying credentials;
establishing, via the service edge device, in response to determining that the walled garden flag has been set, a tunnel into a walled garden.
restricting, via the service edge device, in response to determining that the walled garden flag has been set, access from the at least one customer premises, wherein access is limited to the walled garden;
allowing, via the service edge device, in response to determining that the walled garden flag has not been set, immediate access outside of the walled garden to receive the one or more network services.

17. The method of claim 16, further comprising:
redirecting, via the service edge device, all traffic from the customer premises to a captive portal server;
providing, via the captive portal server, a walled garden portal, wherein the walled garden portal comprises one or more offers to provide at least one network service;
receiving, via the walled garden portal, a customer selection of the at least one network service; and
receiving, via the walled garden portal, customer payment information.

18. The method of claim 17, further comprising:
adjusting, via a network configuration manager, at least a service speed provisioned to the customer premises, based on the customer selection.

19. The method of claim 16, further comprising:
removing, in response to receiving customer payment information, the walled garden flag from the identifying credentials.

20. The method of claim 19, further comprising:
re-flagging the identifying credentials with the walled garden flag when network services to the customer premises are discontinued.
